(19) United States
(12) Patent Application Publication
(10) Pub. No.: US 2026/0095312 A1
(43) Pub. Date: Apr. 2, 2026

(54) SYSTEM AND METHOD FOR DETECTING PHOTON-NUMBER-SPLITTING (PNS) ATTACK IN DECOY BASED DIFFERENTIAL PHASE SHIFT QKD

(71) Applicant: QuNu Labs Private Limited, Bengaluru (IN)

(72) Inventors: Dilip Kumar Singh, Gurgaon (IN); Krishnan Rajesh Kumar, Bengaluru (IN); Shashank Gupta, Fatehpur (IN); Sruthi Chennuri, Hyderabad (IN); Sunil Kumar Gupta, Bangalore (IN)

(21) Appl. No.: 18/895,483

(22) Filed: Sep. 25, 2024

(30) Foreign Application Priority Data
Sep. 27, 2023 (IN) 202341064900

(51) Int. Cl. H04L 9/08; H04L 9/00

(52) U.S. Cl. CPC H04L 9/0852; H04L 9/002

(57) ABSTRACT

Embodiments of a present disclosure relate to communication systems and more particularly to a system and a method for detecting a Photon-Number-Splitting (PNS) attack in a secure quantum communication channel during Quantum Key Distribution (QKD). The system comprises source Quantum Key Distribution (QKD) device that transmits quantum states comprising signal and decoy states to destination QKD device through pre-authenticated classical communication channel. The destination QKD device records measurable parameters and sends them back to source QKD device through pre-authenticated classical communication channel. A source security analysis unit in source QKD device analyzes security parameters and detects Photon-Number-Splitting (PNS) attacks using a differential statistical analysis technique. A source key generation unit and source key management unit perform actions for secret key generation based on detected PNS attack. The destination QKD device generates secret key based on the transmitted measurable parameters.

### EARLIEST PRIORITY DATE

This application claims priority from a Complete patent application filed in IN having Patent Application No. 202341064900, filed on Sep. 27, 2023, and titled “SYSTEM AND METHOD FOR DETECTING PHOTON-NUMBER-SPLITTING (PNS) ATTACK IN DECOY BASED DIFFERENTIAL PHASE SHIFT QKD”.

### FIELD OF INVENTION

Embodiments of a present disclosure relate to communication systems and more particularly to a system and a method for detecting a Photon-Number-Splitting (PNS) attack in a decoy based Differential Phase Shift (DPS) Quantum Key Distribution (QKD).

### BACKGROUND

Generally, Quantum Key Distribution (QKD) is a well-known technique which offers the possibility of secure key distribution. QKD relies on fundamental quantum properties and allows two parties, commonly referred to as Alice and Bob, to exchange a value and know that an eavesdropper, usually referred to as Eve, has not learned much about the value. QKD allows key material to be securely derived by Alice and Bob as needed, which offers significant advantages over other methods of key distribution. QKD, as described however requires an uninterrupted optical path from Alice to Bob to act as a quantum channel.

Currently, secure key distribution is crucial for information security. Current cryptographic systems based on a public-key exchange can be compromised using Shor's algorithm and a large-scale quantum computer. Commercial QKD devices use weak coherent pulses to simulate single photons, however, these contain multi-photon pulses with finite probability, that are vulnerable to Photon-Number-Splitting (PNS) attacks. The use of a low mean photon number results in poor quantum throughput and thus exceptionally low secret bit rates, as well as limiting the possible transmission length due to dark counts in the detectors. The security of QKD is based on the laws of quantum mechanics, which dictate that any attempt to observe the photons by a third party, Eve, will inevitably disturb their state, making it detectable to Alice and Bob. However, commercial QKD systems are vulnerable to multi-photon pulses that are inevitably produced by the attenuated lasers used in current commercial QKD systems. Eve can exploit these multi-photon pulses to launch sophisticated attacks such as the Photon Number Splitting (PNS) attack using quantum non-demolition measurements, which limits the secure key generation and the maximum secure distance. To address this vulnerability, various practical approaches have currently been developed to bridge the gap between the imperfect settings of QKD realization of the theoretical unconditional security proof. One of the recently introduced tools is the decoy-state method, which involves using several different intensities of coherent light pulses as decoy states in addition to signal pulses. The decoy method provides security not only against PNS attacks but also against other collective attacks. Further, another protocol such as a Scarani, Antonio Acin, Gregoire Ribordy, and Nicolas Gisin (SARG04) protocol, is robust when attenuated laser pulses are used instead of single-photon sources. In the SARG04 scheme, Alice wishes to send a private key to Bob. She begins with two strings of bits, and each the strings are ‘n’ bits long. She then encodes these two strings as a string of qubits which is sent to Bob for decoding. For a low Mean Photon Number (MPN), even Differential Phase Shift (DPS) QKD is secure against PNS attack.

Conventionally, a method provides a differential-phase-shift quantum key distribution scheme that uses decoy pulses to detect Photon Number Splitting (PNS) attack. The scheme involves Alice sending a coherent pulse train with occasional high-intensity decoy pulses, and eavesdropping is detected by analyzing photon counting rates around the signal pulses and the decoy pulses. Another conventional method provides a method for detecting photon-number-splitting (PNS) attacks against the differential-phase-shift (DPS) quantum key distribution (QKD) protocol. The conventional method uses a coherent pulse train in DPS QKD to reduce the PNS attack and reduce the distance limitation. Yet another conventional method provides a method for analyzing the decoy state protocol used in QKD systems to improve system throughput and mitigate the threat of Photon Number Splitting (PNS) attacks. Further, another conventional method provides an information processing method for improving the security of a key distribution system. The conventional method involves estimating the degree to which a photon is affected by a photon-number splitting (PNS) attack and performing error correction on the key information based on this estimation. The shared key is obtained only when the estimated ratio of pulses affected by a PNS attack is less than a pre-set threshold. Yet another conventional method provides a method for improving the security of a quantum key distribution (QKD) system using correlated photon pulses. The conventional method involves generating and detecting correlated photon pulses to determine the number of photons in one of the pulses, modulating the pulse and transmitting it to the other QKD station, and detecting the modulated pulses at select timing slots to determine the number of single-photon and multi-photon pulses. Based on the probabilities of detecting single-photon and multi-photon pulses, a security parameter is defined, and the actual numbers of detected pulses are compared to this parameter to assess the presence of eavesdropping.

However, the aforementioned conventional methods and current commercial QKD systems may be vulnerable to the photon number splitting attack due to presence of multi photon pulses with finite probability. Conventional prepare and measure scheme based QKD (DPS) have been shown robust against PNS attack for low mean photon number. However, this severely limits the secure distance and throughput. Further, the current commercial QKD devices based on prepare and measure scheme (Differential Phase Shift (DPS), Coherent One-Way (COW), and the like) do not detect the photon number splitting attacks.

Hence, there is a need in the art for an improved system and method for detecting a Photon-Number-Splitting (PNS) attack in a decoy based Differential Phase Shift (DPS) Quantum Key Distribution (QKD), to address the at least aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

An aspect of the present disclosure provides a system for detecting a Photon-Number-Splitting (PNS) attack in a decoy Differential Phase Shift (DPS) Quantum Key Distribution (QKD). The system includes a source Quantum Key Distribution (QKD) device, which includes a state preparation unit. The state preparation unit generates one or more quantum states comprising a series of N coherent pulses with one or more phases of the one or more quantum states. The one or more quantum states comprises a signal state generated using a signal unit and a decoy state generated using a decoy unit. Further, the system includes a source post-processing unit, which includes a source classical message transmitter unit. The source classical message transmitter unit transmits, through a pre-authenticated classical communication channel, post-processing stage data, to a destination classical message receiver unit associated with a destination Quantum Key Distribution (QKD) device. Further, the source QKD device includes a source classical message receiver unit. The source classical message receiver unit receives, in response to the transmitted post-processing stage data, one or more measurable parameters, from the destination QKD device, through the pre-authenticated classical communication channel. Further, the source QKD device includes a source security analysis unit. The source security analysis unit analyzes one or more security parameters for the signal state and the decoy state based on the one or more measurable parameters. Furthermore, the system includes a source measure and monitor unit. The source measure and monitor unit periodically determines, if each of one or more parametric values corresponding to the analyzed one or more security parameters for the signal state and the decoy state is within each of one or more pre-defined tolerance values for each of the plurality of n-photon pulses. Additionally, the source measure and monitor unit detects a Photon-Number-Splitting (PNS) attack decoy-based Quantum Key Distribution (QKD) in the signal state and the decoy state, when each of one or more parametric values is greater than each of one or more pre-defined tolerance values for each of the plurality of n-photon pulses. The PNS attack is determined using a differential statistical analysis technique. Further, the source QKD device includes a source key generation unit and a source key management unit. The source key generation unit 124 and a source key management unit performs one or more actions corresponding to a secret key generation associated with a Quantum Key Distribution (QKD), based on the detected PNS attack.

Further, the system includes the destination QKD device, which includes a state detection unit. The state detection unit includes a demodulation unit. The demodulation unit receives, through a quantum communication channel, the one or more quantum states from the source QKD device. Further, the demodulation unit decodes quantum information in the received one or more quantum states. Further, the destination QKD device includes a single photon detection unit. The single photon detection unit detects individual photons from the demodulation unit in the received one or more quantum states. Further, the destination QKD device includes a destination post-processing unit. The destination post-processing unit includes a destination classical message receiver unit. The destination classical message receiver unit receives, from the state detection unit, the decoded quantum information in the received one or more quantum states. The destination classical message receiver unit record, for each photon detection event of each of the plurality of n-photons pulses in the received one or more quantum states, using the time stamps, the one or more measurable parameters. Additionally, the destination QKD device includes a destination classical message transmitter unit. Further, the destination classical message transmitter unit transmits the recorded one or more measurable parameters to the source QKD device through the pre-authenticated classical communication channel. Furthermore, the destination QKD device includes the destination classical message receiver unit. The destination receiver unit receives, in response to transmitting the recorded one or more measurable parameters, the generated secret key from the source QKD device, based on the one or more actions corresponding to the secret key generation associated with the QKD. Additionally, the destination QKD device includes a destination measure and monitor unit. The destination measure and monitor unit determine time information and a corresponding single photon detection unit associated with each photon detection event. Further, the destination QKD device includes a destination key generation unit and a destination key management unit. The destination key generation unit and a destination key management unit perform at least one of a termination and a continuation of generating a secret key and assigning key-identity (key-ID), if generating the secret key is continued. Additionally, the system includes a synchronization channel configured to exchange timing information of the source QKD device with the destination QKD device, and coordinate transmission and detection of the one or more quantum states, for synchronizing the clocks of the source QKD device with the destination QKD device to correlate the exchanged timing information.

Another aspect of the present disclosure provides a method for detecting a Photon-Number-Splitting (PNS) attack in decoy Differential Phase Shift (DPS) Quantum Key Distribution (QKD). The method includes generating one or more quantum states comprising a series of N coherent pulses with one or more phases of the one or more quantum states. The one or more quantum states comprises a signal state generated using a signal unit and a decoy state generated using a decoy unit. Further, the method includes transmitting, through a pre-authenticated classical communication channel, post-processing stage data, to a destination classical message receiver unit 140 associated with a destination Quantum Key Distribution (QKD) device. Further, the method includes receiving in response to the transmitted post-processing stage data, one or more measurable parameters, from the destination QKD device through a pre-authenticated classical communication channel. Additionally, the method includes analyzing one or more security parameters for the signal state and the decoy state based on the one or more measurable parameters. Further, the method includes periodically determining, if each of one or more parametric values corresponding to the analyzed one or more security parameters for the signal state and the decoy state is within each of one or more pre-defined tolerance values for each of the plurality of n-photon pulses. Additionally, the method includes detecting a Photon-Number-Splitting (PNS) attack on decoy-based Quantum Key Distribution (QKD) in the signal state and the decoy state, when each of one or more parametric values is greater than each of one or more pre-defined tolerance values for each of the plurality of n-photon pulses. The PNS attack is determined using a differential statistical analysis technique. Further, the method includes performing one or more actions corresponding to a secret key generation associated with a Quantum Key Distribution (QKD), based on the detected PNS attack.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 illustrates an exemplary block diagram representation of a system for detecting a Photon-Number-Splitting (PNS) attack in a decoy Differential Phase Shift (DPS) based Quantum Key Distribution (QKD), in accordance with an embodiment of the present disclosure;

FIG. 2A illustrates an exemplary block diagram representation of a source Quantum Key Distribution (QKD) device as shown in FIG. 1, capable of detecting a Photon-Number-Splitting (PNS) attack in a decoy Differential Phase Shift (DPS) based Quantum Key Distribution (QKD), in accordance with an embodiment of the present disclosure;

FIG. 2B illustrates an exemplary block diagram representation of a destination Quantum Key Distribution (QKD) device as shown in FIG. 1, capable of detecting a Photon-Number-Splitting (PNS) attack in a decoy Differential Phase Shift (DPS) based Quantum Key Distribution (QKD), in accordance with an embodiment of the present disclosure;

FIG. 3 illustrates an exemplary block diagram representation of a source security analysis unit associated with the source Quantum Key Distribution (QKD) device, in accordance with an embodiment of the present disclosure;

FIG. 4 illustrates an exemplary schematic diagram representation of a scenario of a Photon-Number-Splitting (PNS) attack, in accordance with an embodiment of the present disclosure;

FIGS. 5A and 5B illustrate exemplary graph diagram representations of photon dependent yield of pulses related to a signal state and a decoy state with a cycle number to detect the photon-number-splitting attacks, in accordance with an embodiment of the present disclosure;

FIG. 6A is an exemplary flow diagram representation of a method for detecting a Photon-Number-Splitting (PNS) attack in a decoy Differential Phase Shift (DPS) Quantum Key Distribution (QKD), in accordance with an embodiment of the present disclosure; and

FIG. 6B is an exemplary flow diagram representation of a method for transmitting a recorded one or more measurable parameters to a source QKD device, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client, or server computer system) configured by an application may constitute a “module” or a “subsystem” that is configured and operated to perform certain operations. In one embodiment, the “subsystem” may be implemented mechanically or electronically, so a module or a subsystem may comprise dedicated circuitry or logic that is permanently configured (within a special-purpose processor) to perform certain operations. In another embodiment, a “module” or a “subsystem” may also comprise programmable logic or circuitry (as encompassed within a general-purpose processor or other programmable processor) that is temporarily configured by software to perform certain operations.

Accordingly, the term a “module” or a “subsystem” should be understood to encompass a tangible entity, be that an entity that is physically constructed permanently configured (hardwired), or temporarily configured (programmed) to operate in a certain manner and/or to perform certain operations described herein.

Embodiments of the present disclosure provide a system and a method for detecting a Photon-Number-Splitting (PNS) attack in a secure quantum communication channel during Quantum Key Distribution (QKD). The present disclosure provides a system and a method for quantum key distribution which is resilient against Photon-Number-Splitting (PNS) attacks using a Decoy-DPS (DDPS) protocol. For example, the present disclosure enables secure key rate generation at, for example, 33 dB loss using e.g., a standard Indium Gallium Arsenide (InGaAs) avalanche photodiode at e.g., 10% efficiency, allowing for secure key generation in a field situation that corresponds to e.g., 150 km channel separation between a source QKD device and a destination QKD device. The disclosure allows the detection of the PNS attack by utilizing statistical differences between photon-dependent yield and a Quantum Bit Error Rate (QBER) of photon pulses corresponding to a signal state and a decoy-state. The present disclosure indicates that the security of the DDPS protocol against PNS attacks implies security against all kinds of attacks, not just PNS attacks, making it highly secure.

Further, the present disclosure provides a system and a method for security analysis to evaluate a plurality of security conditions at every cycle (e.g., 67 milliseconds), and only if all security conditions are met within the set tolerance value, the contribution of the cycle is considered for secure key generation. The present disclosure extends the decoy method beyond low operating frequencies, mainly in the megahertz rate, to the commercial QKD devices.

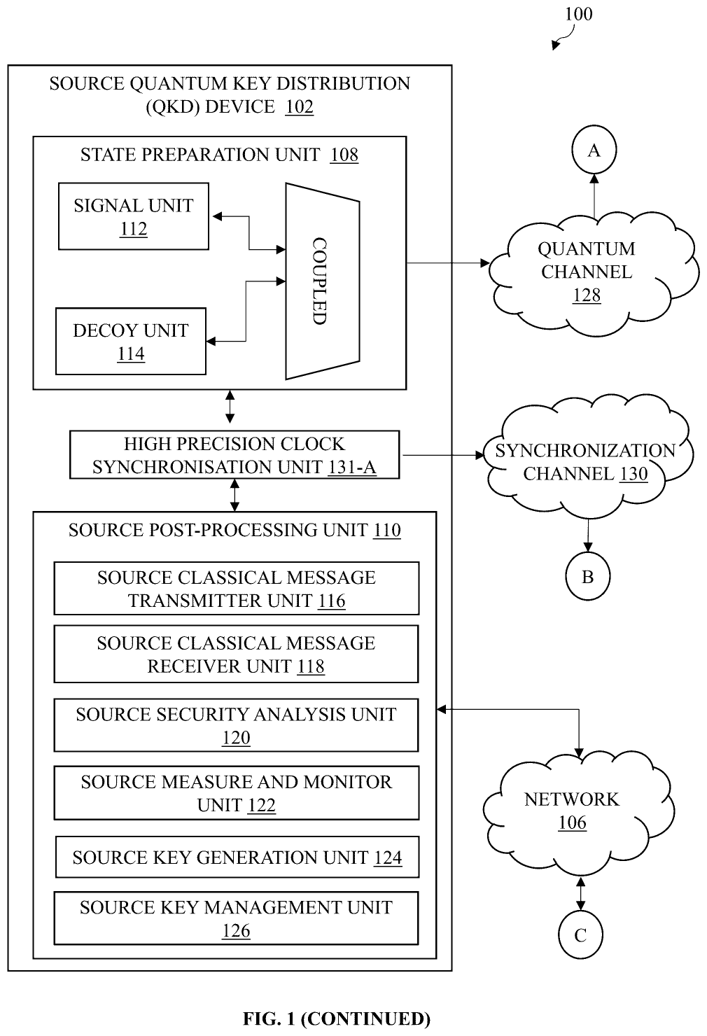

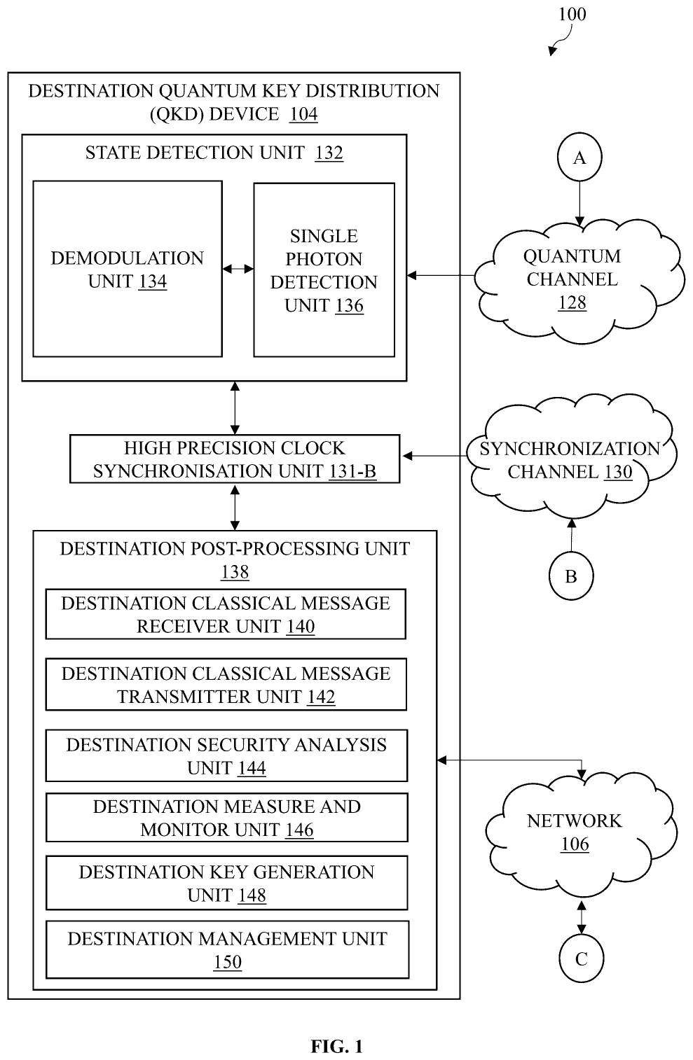

Referring now to the drawings, and more particularly to FIGS. 1 through 6B, where similar reference characters denote corresponding features consistently throughout the figures, there are shown preferred embodiments and these embodiments are described in the context of the following exemplary system and/or method.

FIG. 1 illustrates an exemplary block diagram representation of a system 100 for detecting a Photon-Number-Splitting (PNS) attack in a decoy Differential Phase Shift (DPS) Quantum Key Distribution (QKD), in accordance with an embodiment of the present disclosure. The system 100 includes a source Quantum Key Distribution (QKD) device 102 (hereinafter referred to as the source QKD device 102), and a destination Quantum Key Distribution (QKD) device 104 (hereinafter referred to as the destination QKD device 104), communicatively connected through a communication network 106 (hereinafter referred to as the network 106). The network 106 may be a wired communication network and/or a wireless communication network. Further, a secure quantum communication channel (128 may be associated with the network 106. The secure quantum communication channel 128 may include at least one of, but not limited to, a quantum communication channel and/or a classical communication channel. Therefore, the source QKD device 102, and the destination QKD device 104 may be connected via two channels, one is a quantum communication channel and the second one is a classical communication channel. In an embodiment, the source QKD device 102, and the destination QKD device 104 may enable a point-to-point quantum communication link. The source QKD device 102, and the destination QKD device 104 are the Quantum Key Distribution (QKD) systems. The Point-to-point QKD is a cryptographic technique that uses the principles of quantum mechanics to exchange secret cryptographic keys between two parties, such as the source QKD device 102 and the destination QKD device 104, over a quantum channel. The security of the key exchange is guaranteed by the laws of quantum mechanics, which state that any attempt to eavesdrop on the communication may be detected by the source QKD device 102 and the destination QKD device 104. The key generated through QKD can be used to encrypt and decrypt messages, providing a secure means of communication.

Further, a commercial quantum key distribution (QKD) device may be a system designed for the practical implementation of quantum cryptography in real-world applications. It typically consists of hardware and software components that enable secure communication between two parties by utilizing the principles of quantum mechanics. The commercial QKD device is designed to generate and distribute cryptographic keys that are inherently secure against eavesdropping attacks. Further, the commercial QKD devices are used in various fields such as banking, defense, and government, where the security of communication is critical. These devices are typically compact, easy to use, and suitable for deployment in a variety of environments, including both indoor and outdoor settings.

Also, a quantum network such as the network 106 of the system 100 may be any known network type. The quantum network may be comprised of an arrangement of free space transmitters and receivers forming a free space network. In an embodiment, the quantum network may also comprise waveguide links between the nodes, for instance, fibre optic. The quantum network may be implemented purely for QKD purposes, i.e., the quantum network may be a backbone carrying QKD signals only, to establish quantum keys between devices/nodes that can then be used to encrypt conventional communications between the devices/nodes sent via some other medium, for instance via another network—a wired electrical, wireless, or separate quantum network for example.

The classic communication channel may be a wired or a wireless network, and the quantum communication channel and the network 106 can be a fibre channel, a quantum channel in free space, and the like. The classic communication channel may be a direct point-to-point physical connection between two devices/nodes or can be a logic connection established by connecting the two devices/nodes to a classic network. The quantum communication channels are optical networks which may be any known type of optical network allowing an exchange of suitable quantum signals.

In an embodiment, the system 100 may include the source QKD device 102. The source QKD device 102 includes a state preparation unit 108. In an embodiment, the state preparation unit 108 may be configured to generate one or more quantum states comprising a series of N coherent pulses with one or more phases of the one or more quantum states. The one or more quantum states comprises a signal state generated using a signal unit 112 and a decoy state generated using a source security analysis unit 120. In an embodiment, the source QKD device 102 includes a source post-processing unit 110. The source post-processing unit 110 includes a source classical message transmitter unit 116. The source classical message transmitter unit 116 may be configured to transmit, through a pre-authenticated classical communication channel (not shown), post-processing stage data, to a destination classical message receiver unit 140 associated with the destination QKD device 104. The source classical message transmitter unit 116 may perform, for example, post-processing operations, such as but not limited to, sifting, parameter estimation, error correction, privacy amplification, and the like. In an embodiment, the signal state carries a message, and the decoy state is used to detect eavesdropping. The one or more quantum states are generated using a chain of optical components (not shown in FIG. 1) comprising a laser, an inline polarizer, a true random number generator, an intensity modulator, a Delay Line Interferometer (DLI), and a phase modulator. The intensity modulator and the pulse modulator are used to randomly generate signal pulses of the signal state or decoy pulses of the decoy state. The true random number generator is used to randomly select the signal pulses and the decoy pulses.

In an embodiment, the source post-processing unit 110 includes a source classical message receiver unit 118. The source classical message receiver unit 118 may be configured to receive, in response to the transmitted post-processing stage data, one or more measurable parameters, from the destination QKD device 104 through the pre-authenticated classical communication channel. The one or more measurable parameters include, but are not limited to, at least one of a pulse gain and a quantum bit error rate (QBER) for the signal state and the decoy state.

In an embodiment, the source QKD device 102 includes a source security analysis unit 120. The source security analysis unit 120 may be configured to analyze one or more security parameters for the signal state and the decoy state based on the one or more measurable parameters. The one or more security parameters include, but are not limited to, a photon number dependent yield, a photon dependent yield of at least one of the signal state and the decoy state pulses, a photon dependent yield quantum bit error rate (QBER), and a photon dependent QBER. For example, a drop in yield can be caused by numerous factors, including losses in the quantum channel (such as absorption, scattering, or reflection), errors in the measurement and detection process, or environmental noise (such as temperature fluctuations or electromagnetic interference). These factors can cause errors and decoherence in the quantum states, leading to a lower success rate in the key exchange process.

Further, the source QKD device 102 includes a source measure and monitor unit 122. The source measure and monitor unit 122 may be configured to periodically determine, if each of one or more parametric values corresponding to the analyzed one or more security parameters for the signal state and the decoy state is within each of one or more pre-defined tolerance values for each of the plurality of n-photon pulses. Furthermore, the source measure and monitor unit 122 may be configured to detect a Photon-Number-Splitting (PNS) attack, when each of one or more parametric values is greater than each of one or more pre-defined tolerance values for each of the plurality of n-photon pulses. The PNS attack is determined using a differential statistical analysis technique.

In an embodiment, the source QKD device 102 includes a source key generation unit 124 and a source key management unit 126. The source key generation unit and a source key management unit 126 may be configured to perform one or more actions corresponding to a secret key generation associated with a Quantum Key Distribution (QKD), based on the detected PNS attack. In an embodiment, performing the one or more actions include, but are not limited to, termination of secret key generation, a continuation of secret key generation, discarding the plurality of n-photon pulses, error correction for the photon detection event, privacy amplification, calculating a lower bound of a single photon yield, calculate an upper bound on a single photon quantum bit error rate (QBER), calculate a theoretical secret key rate, calculate a compression to be applied on an error corrected raw secret keys, compress the secret keys, generate secure secret keys, and the like.

In an embodiment, the system 100 may include the destination QKD device 104. The destination QKD device 104 includes a state detection unit 132. The state detection unit 132 includes a demodulation unit 134. The demodulation unit 134 may be configured to receive, through the pre-authenticated classical communication channel, the post-processing stage data from the source classical message transmitter unit 116 associated with the source QKD device 102. The demodulation unit 134 decode quantum information in the received one or more quantum states. The destination QKD device 104 includes a single photon detection unit 136. The single photon detection unit 136 detects individual photons from the demodulation unit 134 in the received one or more quantum states. Furthermore, the destination QKD device 104 includes a destination post-processing unit 138. The destination post-processing unit 138 further includes a destination classical message receiver unit 140. The destination classical message receiver unit 140 receive from the state detection unit 132, the decoded quantum information in the received one or more quantum states. Further, the destination classical message receiver unit 140 records, for each photon detection event of each of the plurality of n-photons pulses in the received one or more quantum states, using the time stamps, the one or more measurable parameters.

In an embodiment, the destination QKD device 104 includes a destination classical message transmitter unit 142. The destination classical message transmitter unit 142 may be configured to transmit the recorded one or more measurable parameters to the source QKD device 102 through the pre-authenticated classical communication channel.

In an embodiment, the destination QKD device 104 includes a destination classical message receiver unit 140. The destination receiver unit 140 may be configured to receive, in response to transmitting the recorded one or more measurable parameters, the generated secret key from the source QKD device 102, based on the one or more actions corresponding to the secret key generation associated with the QKD.

Furthermore, the destination QKD device 104 includes a destination measure and monitor unit 146 configured to determine time information and a corresponding single photon detection unit 136 associated with each photon detection event. Furthermore, the destination QKD device 104 includes a destination key generation unit 148 and a destination key management unit 150. The destination key generation unit 148 and a destination key management unit 150 perform at least one of a termination and a continuation of generating a secret key and assigning key-identity (key-ID), if the secret key generation is continued. The system 100 includes a synchronization channel 130 configured to exchange timing information of the source QKD device 102 with the destination QKD device 104, and coordinate transmission and detection of the one or more quantum states for synchronizing the clocks of the source QKD device 102 with the destination QKD device 104 to correlate the exchanged timing information.

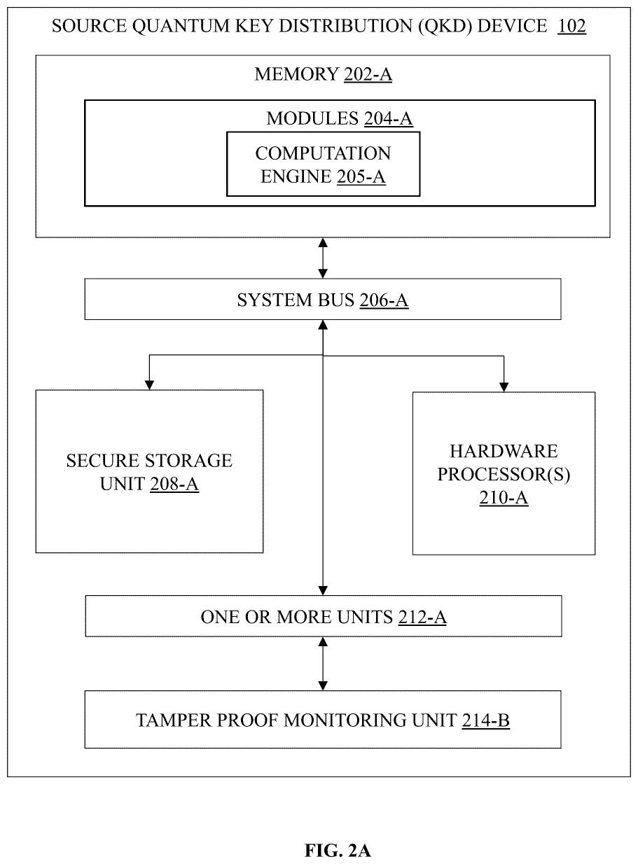

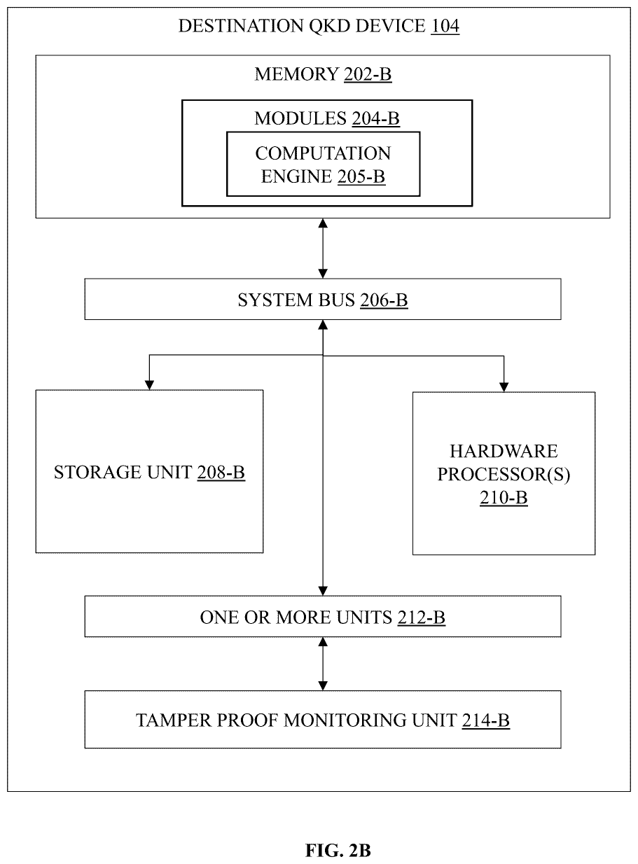

The components of the source QKD device 102, and a destination QKD device 104 are described in more detail in FIGS. 2A and 2B, respectively.

Those of ordinary skilled in the art will appreciate that the hardware depicted in FIG. 1 may vary for particular implementations. For example, other peripheral devices such as an optical disk drive and the like, a Local Area Network (LAN), a Wide Area Network (WAN), a Wireless (e.g., Wireless-Fidelity (Wi-Fi)) adapter, a graphics adapter, a disk controller, an input/output (I/O) adapter also may be used in addition or in place of the hardware depicted. The depicted example is provided for the purpose of explanation only and is not meant to imply architectural limitations with respect to the present disclosure.

Those skilled in the art will recognize that, for simplicity and clarity, the full structure and operation of all data processing systems suitable for use with the present disclosure are not being depicted or described herein. Instead, only so much of a quantum key distribution system as is unique to the present disclosure or necessary for an understanding of the present disclosure is depicted and described. The remainder of the construction and operation of the quantum key distribution system may conform to any of the various current implementations and practices known in the art.

FIG. 2A illustrates an exemplary block diagram representation of a source Quantum Key Distribution (QKD) device 102 as shown in FIG. 1, capable of detecting a Photon-Number-Splitting (PNS) attack in a secure quantum communication channel during Quantum Key Distribution (QKD), in accordance with an embodiment of the present disclosure. The source QKD device 102 includes a memory 202-A, a system bus 206-A, a storage unit 208-A, a hardware processor(s) 210-A, and one or more units 212-A.

The single photons comprising each of these entangled pairs are sent to other nodes in the quantum network via free-space communication links (such as quantum links). In an exemplary embodiment, a polarization state of photons is used to encode key bits.

The memory 202-A and the hardware processor 210-A may be communicatively coupled by a system bus 206-A or a similar mechanism. The hardware processor(s) 210-A, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The hardware processor(s) 210-A may also include embedded controllers, such as generic or programmable logic devices or arrays, application specific integrated circuits, single-chip computers, and the like.

The memory 202-A may be non-transitory volatile memory and non-volatile memory. The memory 202-A may be coupled for communication with the hardware processor(s) 210-A, such as being a computer-readable storage medium. The hardware processor(s) 210-A may execute machine-readable instructions and/or source code stored in the memory 202-A. A variety of machine-readable instructions may be stored in and accessed from the memory 202-A. The memory 202-A may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 202-A includes a plurality of modules/subsystems stored in the form of machine-readable instructions on any of the above-mentioned storage media and may be in communication with and executed by the hardware processor(s) 210-A.

The memory 202-A includes a plurality of modules 204-A in the form of programmable instructions executable by the hardware processor(s) 210-A. The plurality of modules 204-A may be configured to execute the one or more units 212-A. The one or more units 212-A include state preparation unit 108, the source classical message transmitter unit 116, the source classical message receiver unit 118, the source security analysis unit 120, a source measure and monitor unit 122, and source key generation unit 124 and a source key management unit 126.

In an embodiment, the system 100 may include the source QKD device 102. The source QKD device 102 includes a state preparation unit 108. In an embodiment, the state preparation unit 108 may be configured to generate one or more quantum states comprising a series of N coherent pulses with one or more phases of the one or more quantum states. The one or more quantum states comprises a signal state generated using a signal unit 112 and a decoy state generated using a source security analysis unit 120. In an embodiment, the source QKD device 102 includes a source post-processing unit 110. The source post-processing unit 110 includes a source classical message transmitter unit 116.

In an embodiment, the source transmitter unit 108 may be configured to transmit, through a pre-authenticated classical communication channel, post-processing stage data, to a destination classical message receiver unit 140 associated with the destination QKD device 104. In an embodiment, the signal state carries a message, and the decoy state is used to detect eavesdropping. The one or more quantum states are generated using a chain of optical components (not shown in FIG. 2A) comprising a laser, an inline polarizer, a true random number generator, an intensity modulator, a Delay Line Interferometer (DLI), and a phase modulator. The intensity modulator and the pulse modulator are used to randomly generate signal pulses of the signal state or decoy pulses of the decoy state. The true random number generator is used to randomly select the signal pulses and the decoy pulses.

Jn an embodiment, the source post-processing unit 110 includes a source classical message receiver unit 118, which may be configured to receive, in response to the transmitted post-processing stage data, one or more measurable parameters, from the destination classical message receiver unit 140 associated with the destination QKD device 104 through the pre-authenticated classical communication channel. The one or more measurable parameters include, but are not limited to, at least one of a pulse gain and a quantum bit error rate (QBER) for the signal state and the decoy state.

Jn an embodiment, a source security analysis unit 120 may be configured to analyze one or more security parameters for the signal state and the decoy state based on the one or more measurable parameters. The one or more security parameters include, but are not limited to, a photon dependent yield, a photon dependent yield of at least one of the signal state and the decoy state pulses, a photon number dependent quantum bit error rate (QBER), and a photon dependent QBER. For example, a drop in yield can be caused by numerous factors, including losses in the quantum channel (such as absorption, scattering, or reflection), errors in the measurement and detection process, or environmental noise (such as temperature fluctuations or electromagnetic interference). These factors can cause errors and decoherence in the quantum states, leading to a lower success rate in the key exchange process.

In an embodiment, to analyze the one or more security parameters for the signal state and the decoy state, the source measure and monitor unit 122 may be further configured to determine, if each of the one or more parametric values corresponding to a photon number dependent yield of the plurality of n-photon pulses in the signal state and the decoy state is within each of the one or more pre-defined tolerance values for each of the plurality of n-photon pulses. Further, the source measure and monitor unit 122 may be configured to determine, if each of the one or more parametric values corresponding to a photon number dependent quantum bit error rate (QBER) of the plurality of n-photon pulses in the signal state and the decoy state is within each of the one or more pre-defined tolerance values for each of the plurality of n-photon pulses.

In an embodiment, the source QKD device 102 includes a source measure and monitor unit 122. The source measure and monitor unit 122 may be configured to periodically determine, if each of one or more parametric values corresponding to the analyzed one or more security parameters for the signal state and the decoy state is within each of one or more pre-defined tolerance values for each of the plurality of n-photon pulses. Furthermore, the source measure and monitor unit 122 may be configured to detect a Photon-Number-Splitting (PNS) attack, when each of one or more parametric values is greater than each of one or more pre-defined tolerance values for each of the plurality of n-photon pulses. The PNS attack is determined using a differential statistical analysis technique.

In an embodiment, the source measure and monitor unit 122 may further be configured to monitor channel losses and induced errors for the signal state and the decoy states are constant over the quantum communication channel, to detect the PNS attack.

In an embodiment, the source QKD device 102 includes a source key generation unit 124 and a source key management unit 126. The source key generation unit and a source key management unit 126 may be configured to perform one or more actions corresponding to a secret key generation associated with a Quantum Key Distribution (QKD), based on the detected PNS attack. In an embodiment, performing the one or more actions include, but are not limited to, termination of secret key generation, a continuation of secret key generation, discarding the plurality of n-photon pulses, error correction for the photon detection event, privacy amplification, calculating a lower bound of a single photon yield, calculate an upper bound on a single photon quantum bit error rate (QBER), calculate a theoretical secret key rate, calculate a compression to be applied on an error corrected raw secret keys, compress the secret keys, generate secure secret keys, and the like.

FIG. 2B illustrates an exemplary block diagram representation of a destination Quantum Key Distribution (QKD) device 104 as shown in FIG. 1, capable of detecting a Photon-Number-Splitting (PNS) attack in a secure quantum communication channel during Quantum Key Distribution (QKD), in accordance with an embodiment of the present disclosure. The destination QKD device 104 includes a memory 202-B, a system bus 206-B, a storage unit 208-B, a hardware processor(s) 210-B, and one or more units 212-B.

The memory 202-B and the hardware processor(s) 210-B may be communicatively coupled by a system bus 206-B or a similar mechanism. The hardware processor(s) 210-B, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The hardware processor(s) 210-B may also include embedded controllers, such as generic or programmable logic devices or arrays, application specific integrated circuits, single-chip computers, and the like.

The memory 202-B may be non-transitory volatile memory and non-volatile memory. The memory 202-B may be coupled for communication with the hardware processor(s) 210-B, such as being a computer-readable storage medium. The hardware processor(s) 210-B may execute machine-readable instructions and/or source code stored in the memory 202-B. A variety of machine-readable instructions may be stored in and accessed from the memory 202-B. The memory 202-B may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 202-B includes a plurality of modules/subsystems stored in the form of machine-readable instructions on any of the above-mentioned storage media and may be in communication with and executed by the hardware processor(s) 210-B.

The memory 202-B includes a plurality of modules 204-B in the form of programmable instructions executable by the hardware processor(s) 210-B. The plurality of modules 204-B may be configured to execute the one or more units 212-B. The one or more units 212-B include a state detection unit 132, demodulation unit 134, a destination post-processing unit 138, destination classical message receiver unit 140, the destination classical message transmitter unit 142, a destination classical message receiver unit 140, a destination measure and monitor unit 146, and a destination key generation unit 148.

Jn an embodiment, the system 100 may include the destination QKD device 104. The destination QKD device 104 includes a state detection unit 132. The state detection unit 132 includes a demodulation unit 134. The demodulation unit 134 may be configured to receive, through the pre-authenticated classical communication channel, the post-processing stage data from the source classical message transmitter unit 116 associated with source QKD device 102. The demodulation unit 134 decode quantum information in the received post-processing stage data. The destination QKD device 104 includes a single photon detection unit 136. The single photon detection unit 136 detects individual photons from the demodulation unit 134 in the received one or more quantum states. Furthermore, the destination QKD device 104 includes a destination post-processing unit 138. The destination post-processing unit 138 further includes a destination classical message receiver unit 140. The destination classical message receiver unit 140 receives from the state detection unit 132, the decoded quantum information in the received one or more quantum states. Further, the destination classical message receiver unit 140 records, for each photon detection event of each of the plurality of n-photons pulses in the received one or more quantum states, using the time stamps, the one or more measurable parameters.

Jn an embodiment, the destination classical message transmitter unit 142 may be configured to transmit the recorded one or more measurable parameters to the source QKD device 102 through the pre-authenticated classical communication channel.

In an embodiment, the classical message destination receiver unit 140 may be configured to receive, in response to transmitting the recorded one or more measurable parameters, the generated secret key from the source QKD device 102, based on the one or more actions corresponding to the secret key generation associated with the QKD. Furthermore, the destination QKD device 104 includes a destination measure and monitor unit 146 configured to determine time information and a corresponding single photon detection unit 136 associated with each photon detection event. Furthermore, the destination QKD device 104 includes a destination key generation unit 148 and a destination key management unit 150. The destination key generation unit 148 and a destination key management unit 150 perform at least one of a termination and a continuation of generating a secret key and assigning key-identity (key-ID), if the secret key generation is continued. The system 100 includes a synchronization channel 130 configured to exchange timing information of the source QKD device 102 with the destination QKD device 104, and coordinate transmission and detection of the one or more quantum states for synchronizing the clocks of the source QKD device 102 with the destination QKD device 104 to correlate the exchanged timing information.

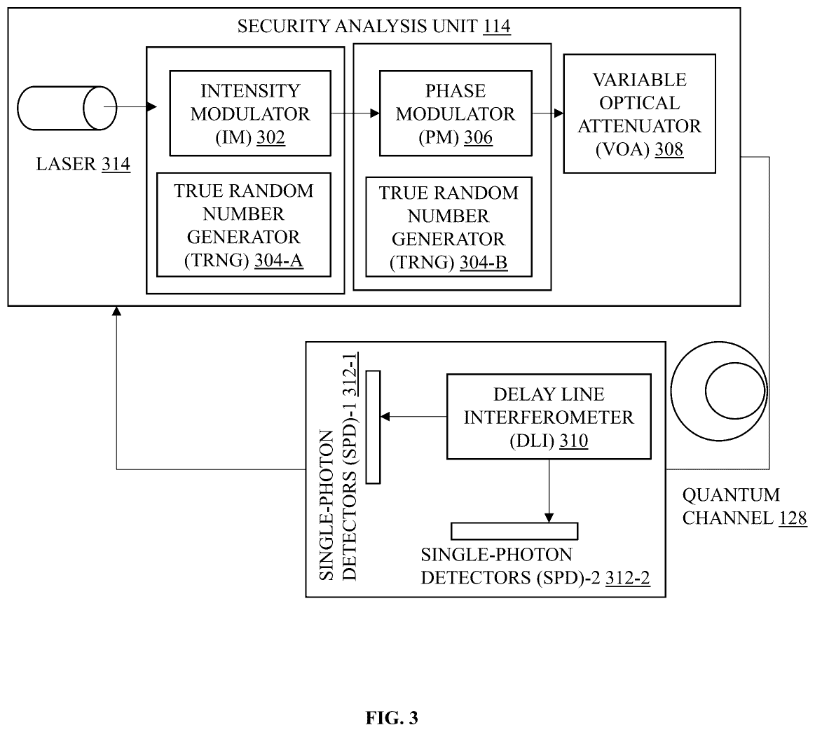

FIG. 3 illustrates an exemplary block diagram representation of the source security analysis unit 120 associated with the source QKD device 102, in accordance with an embodiment of the present disclosure. The source security analysis unit 120 includes a plurality of decoy state protocol blocks in the QKD using an intensity modulation (IM) 302, a True Random Number Generator (TRNG) 304-A and 304-B, a phase modulation (PM) 306, a variable optical attenuator (VOA) 308, a Delay Line Interferometer (DLI) 310, a Single Photon Detectors (SPD) 312-1 and 312-2 can enhance the security of the QKD system 100.

For example, the source QKD device 102 may use the IM 302 to randomly generate signal and decoy pulses, which are then subjected to attenuation by the VOA 308. The IM 302 and the TRNG 304 are used together to generate random phase values that are applied to the signal and decoy pulses of the signal state and decoy state, respectively, by the PM 306. The signal and decoy pulses are then combined using the DLI 310, which creates interference between the two types of pulses. The resulting interference pattern is detected by the SPDs 312-1, and 312-2. The destination QKD device 104 uses the measurement results to extract the secret key.

By using the decoy states with different mean photon numbers, the destination QKD device 104 can detect if an eavesdropper is present and attempt to intercept the transmission. The use of DPS blocks with IM 302, TRNG 304, PM 306, VOA 308, DLI 310, and SPD 312 can significantly improve the security of the QKD system 100 and make it more resistant to attacks by eavesdroppers. In the decoy state protocol blocks in the QKD, several components are commonly used to prepare and manipulate the quantum states, as well as to measure them. These components can include the IM 302, where the source QKD device 102 uses the IM 302 to modulate the intensity of the laser pulses, allowing the source QKD device 102 to randomly generate signal and decoy pulses. The TRNG 304 is used to generate a random sequence of numbers, which is used to control the intensity of the pulses generated by the IM 302. Further, the PM 306 is used to modulate the phase of the laser pulses, allowing the source QKD device 102 to encode the secret key bits into the quantum states. The source QKD device 102 uses the VOA 308 to attenuate the transmission power of the laser pulses, creating the decoy states with different mean photon numbers. Further, the DLI 310 is used to separate the signal and decoy states and to align them in time. Additionally, the SPDs 312 is used by the destination QKD device 104 to measure the quantum states sent by the source QKD device 102 and to detect any potential eavesdropping.

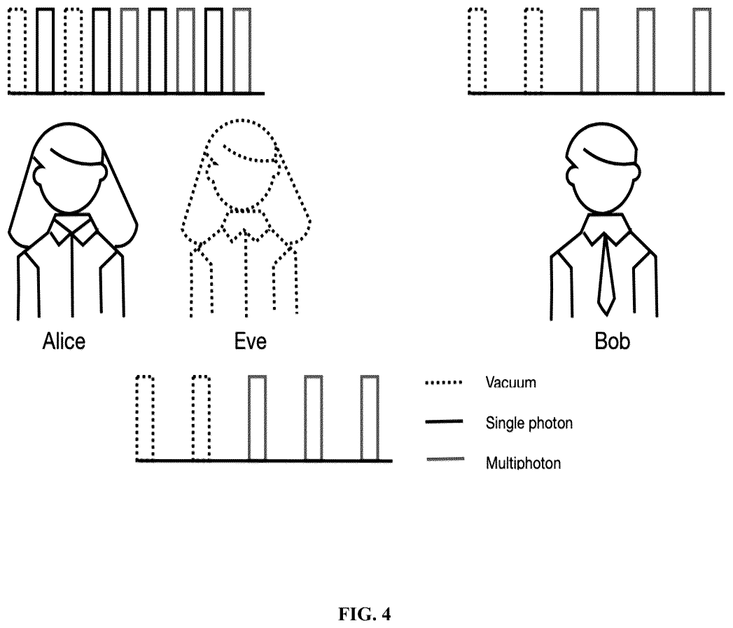

FIG. 4 illustrates an exemplary schematic diagram representation of a scenario of a Photon-Number-Splitting (PNS) attack, in accordance with an embodiment of the present disclosure. In FIG. 4, Eve is coming close to Alice side, blocking all the single photon pulses, and sending multi photon pulses to Bob after keeping one photon with itself. Eve mimics all the post-processing stages and at the end, Eve has an exact key that Alice and Bob thinks is secure. This totally compromise the security of commercial QKD). For example, an Eve (attacker/eavesdropper) as shown in FIG. 4 may be limited only by the laws of physics, so the Eve has the technology to perform Quantum Non-Demolition (QND) measurements (counts the number of photons in a pulse). For example, Eve performs quantum non-demolition experiment by tapping pulses close to Alice node. She blocks all the single photon pulses and retains a photon from multi photon pulses in quantum memory and send remaining photons to the Bob node through a modified quantum channel such that the gain remains constant. At the end, Eve and Bob will have the identical pulses and hence the identical keys. The Eve also has a quantum memory to store a single photon quantum state in it with an arbitrarily large coherence time. Eve attacks the pulses close to an Alice (i.e., the source QKD device 102). Eve blocks the single-photon pulses and the multi-photon pulses, and Eve stores one photon in a quantum memory and forwards the remaining photons to Bob (i.e., the destination QKD device 104) using a noiseless quantum channel. In summary, Eve's task is to block the single-photon pulses and tap multi-photon pulses such that the overall counts at Bob's remain unaltered. The presence of more than one photon in some pulses allows the adversary to keep one copy of the photon in its quantum memory and sends the remaining copies to the Bob (i.e., the destination QKD device 104). Eve does this without destroying the phase information of the photons. Eve and Bob end up with the same information encoded in the photons. This is represented in FIG. 4, each attack begins with the adversary measuring the number of photons, i.e., applying an observable which corresponds to the probability projection valued measure {Pⱼ}ⱼ₌₀^{∞}, where Pj=Σⱼ|j> <j|. Such attacks can completely compromise the security of commercial QKD devices. In practice, such a non-demolition measurement has not yet been implemented with significant efficiency, however, it is possible in theory, due to the corresponding probability projector-valued measure exists. If the pulse contains a single photon, the adversary can still find out the information encoded in it only at the cost of changing the state and, accordingly, introducing errors. Therefore, the adversary can block all or part of single-photon states, i.e., stop their transmission to the Bob (the destination QKD device 104), simulating natural losses in the communication channel. They can attack unblocked single-photon states in the usual way (at the cost of introducing errors). The final objective of Eve is to hide behind the channel loss by mimicking the behavior of the quantum channel between Alice and Bob. Eve's PNS attack strategy is (1.) Eve blocks all single-photon pulses and for the multi-photon pulses, she stores one photon in a quantum memory. Eve forwards the remaining photons to Bob through a channel such that pulse gain remains unchanged. (2.) Eve can have the same setup as Bob to determine the relative phase information of the photon captured (quantum memory not required) and performs the exact post-processing operations as Bob.

In an embodiment, the source QKD device 102 may be configured to analyze one or more security parameters for the signal state and the decoy state based on one or more measurable parameters. Further, the source QKD device 102 may be configured to periodically determine, if each of one or more parametric values corresponding to the analyzed one or more security parameters for the signal state and the decoy state is within each of one or more pre-defined tolerance values for each of the plurality of n-photon pulses. Furthermore, the source QKD device 102 may be configured to detect a Photon-Number-Splitting (PNS) attack, when each of one or more parametric values is greater than each of one or more pre-defined tolerance values for each of the plurality of n-photon pulses. The PNS attack on the quantum channel is determined using a differential statistical analysis technique.

### Exemplary Scenario:

Consider the decoy method, which enables QKD systems 100 to use conventional signal states as well as dedicated security states, such as decoy and vacuum states. The signal states transmit quantum pulses or qubits that generate the shared secret key, while decoy states to increase the chances of detecting photon number splitting (PNS) attack, on the quantum channel through statistical differentiation with the signal state. Vacuum states are used to determine the detector's dark count rate in the absence of photons. Decoy pulses also improve the accuracy of parameters required to determine the secure key rate, including estimating a tight lower bound on the signal clicks corresponding to the single photon state and determining a tight upper bound on the signal QBER corresponding to the single photon pulses. In this protocol, Alice randomly selects the type of state based on predetermined occurrence percentages of signal and decoy pulses.

The increased Mean Photon-Number (MPN) of the signal state in this protocol leads to higher key distribution rates and greater operational distances. For example, an MPN of e.g., 0.7 is greater than the traditionally used 0.1, since the percentage of single-photon pulses increases until an MPN of 1 for a light source following a Poissonian distribution. Using different MPNs for the signal and decoy states allows the QKD system to detect photon number-splitting attack (PNS) using the decoy state protocol security condition.

The Decoy-DPS (DDPS) protocol involves quantum exchange, security checks, classical post-processing, and secret key generation. During the quantum exchange, both signal and decoy photon pulses are generated, transmitted, and detected, with only Alice knowing which pulse Bob then shares the time stamp data of the detection events with Alice. In security check 1.0, Alice determines the photon-dependent yield for decoy and signal pulses using Bob's time stamp information and can choose to abort or continue the secret key generation based on the baseline yield of decoy, signal, and their tolerance.

In classical post-processing, Alice discards all pulses not detected by Bob and performs bi-directional error correction by initially performing parameter estimation using all the bit values corresponding to all decoy pulses and 15% of randomly chosen signal pulses from Bob. Alice then estimates the photon-dependent QBER of the decoy and signal and their tolerance, randomly selecting time stamps corresponding to signal or decoy pulses without disclosing their identities. In security check 2.0, if the QBER statistics match, Alice proceeds with error correction for the remaining signal clicks and applies privacy amplification. Finally, Alice calculates the lower bound of the single photon yield, the upper bound on the single photon QBER, and the theoretical secret key rate, and generates the secure keys with Bob after compression.

To satisfy the security condition for the decoy state protocol, the channel losses and induced errors must remain constant over the quantum channel. The security condition for yields and errors requires yields and QBERs to be within a certain tolerance, which is determined during security check 1.0. The general requirement for the decoy state protocol security condition is that the channel losses and induced errors should remain constant over a given quantum channel. The security condition (i.e., security parameters) for yields and errors is described in equations 1 and 2 below:

$${y}_{n} = {y}_{n}^{s} \pm {δ}_{y}^{s} = {y}_{n}^{d} \pm {δ}_{y}^{d} \qquad Equation 1$$

$${e}_{n} = {e}_{n}^{s} \pm {δ}_{e}^{s} = {e}_{n}^{d} \pm {δ}_{e}^{d} \qquad Equation 2$$

In the above equations 1 and 2, variable ‘yₙ’ may denotes the photon number dependent yield and is defined as the conditional probability that Bob detects an optical pulse given that Alice sent an n-photon pulse that can be a signal or decoy pulse. Further, the variable

$$‘ {y}_{n}^{x} ’ ( x = s or d )$$

denotes the photon-dependent yield of signal (s) or decoy (d) pulses. Further, the variable ‘eₙ’ denotes the photon number dependent QBER and is defined as the conditional probability that an error occurred given that Bob detects the n-photon pulse from Alice. Furthermore, the variable eₙ (x=s or d) denotes the respective value for the signal and decoy pulses, and the variable

$$‘ {δ}_{y}^{x} ’ and ‘ {δ}_{e}^{x} ’$$

are the tolerance values associated with the photon-dependent yield and QBER, respectively.

The security condition described above requires that the yields (yn) and QBERs (en) for the signal and decoy states should be equal (within certain tolerances) for each n-photon pulse. This is because the quantum transmission efficiency and error rate remain constant for the quantum channel. However, in practical implementations and experiments, the photon-number-dependent yields (ysn, ydn) and QBERs (esn, edn) cannot be precisely measured using current single-photon detectors, which are threshold detectors and cannot determine the exact number of photons in each pulse. Therefore, Alice and Bob can only estimate the n-photon yields (Yn) and n-photon QBERs (en) from measurable parameters such as gains and QBERs for both signal and decoy pulses. Estimating photon-dependent yield from gain: Both signal and decoy pulses follow Poisson distribution. Therefore, the pulse gain is shown in equation 3 below:

$${G}_{x} = {\sum }_{n = 0}^{∞} {y}_{n}^{x} \frac{{e}^{- {x}_{x} n}}{n !} = {y}_{0} + 1 - {e}^{- x η} \qquad Equation 3$$

In the above equation 3, ‘x=‘s’ or ‘d’ depends on signal pulse (s) or decoy pulse (d), and the variable ‘η=−ln|1+Y0−Gx/x|’ is the end-to-end channel efficiency. The photon-dependent efficiency (ηn=1−(1−η)ⁿ). The photon-dependent yield is given in equation 4 below:

$${y}_{n} = {y}_{0} + {η}_{n} - {y}_{0} {η}_{n} ≅ {y}_{0} + {η}_{n} {y}_{n}^{x} ≅ {y}_{0} + 1 - {( 1 - [ \frac{- ln \vert 1 + {y}_{0} - {G}_{x} \vert}{x} ] )}^{n} \qquad Equation 4$$

In above equation 4, the variable ‘y₀’ denotes the dark counts.

Further, estimating photon dependent QBER and photon dependent yield is defined in equation 5 below:

$${e}_{n} = \frac{{y}_{0} {e}_{0} + {η}_{x} {e}_{detected}}{{y}_{n}} \qquad Equation 5$$

In the above equation 5, the variable ‘e₀’ is the error associated with vacuum states (½) and the variable ‘e_{detected}’ is the actual observed QBER.

From a mathematical point of view, the statistics of detecting states with different intensities gives the legitimate parties additional equations for a better estimation of unknown parameters, such as the number of positions in the sifted key obtained from single-photon pulses (i.e., those that cannot be intercepted without introducing errors) and the fraction of errors in them. Using this, we can estimate the maximum achievable secret key rate and perform the privacy amplification accordingly. Let us focus on the security analysis of the Decoy-DPS protocol next. The security analysis of a QKD system involves determining the achievable secret key rate, which is the rate at which the system can ensure that the adversary has infinitesimal information about the final key. This requires compression in the privacy amplification procedure. The final secret key rate is obtained as the limit of the ratio of the length of the final key to the length of the sifted key as the number of pulses tends to infinity.

The maximum secret key rate can be determined using a Devetak-Winter theorem. This theorem involves a three-particle state of the sender (Alice), the receiver (Bob), and the adversary (Eve) after the sifting procedure. The three-particle state can be expressed as shown in equation 6 below:

$$\begin{matrix}ρ {A}^{′} BE = {( {Q}^{s} )}^{- 1} ( I ⊗ γ ) ( ρ {A}^{′} A ) \\ = \frac{1}{2 {Q}^{s}} {\sum }_{u = 0}^{1} \vert u > a < u \vert ⊗ γ ( {ρ}_{μ u} )\end{matrix} \qquad Equation 6$$

In the above equation 6, the variable Q^{s}=Tr [((I_{A′}⊗γ)(ρA′A))],

$$ρ {A}^{′} A = \frac{1}{2} {\sum }_{u = 0}^{1} \vert u > {A}^{′} < u \vert ⊗ {ρ}_{μ u} ,$$

and

$${ρ}_{μ u} = exp ( - μ ) \vert 0 > < 0 \vert + exp ( - μ ) {\sum }_{j = 1}^{∞} \frac{{μ}^{j}}{j !} \vert {Ψ}_{j} > < {Ψ}_{j} \vert$$

According to the Devetak Winter theorem, the maximal secret key rate is shown in equation 7 below:

$$R = H ( {A}^{′} \vert E ) - H ( {A}^{′} \vert B ) \qquad Equation 7$$

In the above equation 7, H(A′|B)=H(ρA′B−H(ρB)) and H(A′|E)=(ρA′E−H(ρE)) are the quantum conditional entropies. Here, we have used the following convention regarding the denotations of the states of subsystems of a composite system:
if the state of the composite system is ρA′BE, then ρA′B=Tr_{E}(ρA′BE),ρB=Tr_{A′E}(ρA′BE), ρE=Tr_{A′B}(rA′BE), and the like. The H(A′|E) characterizes the ignorance or the lack of information of the adversary about the sender's key bit. H(A′|B) characterizes the ignorance (the lack of information) of the receiver about the same bit. Denote ‘m’ as the minimal amount of information that the sender has to disclose about their sifted key, so that the receiver would be able to correct all errors and get a key that matches the sender's key.
According to the Fano inequality, the quantity H(A′|B) can be upper bounded by ‘h(e),’ where h(e)=−e log e−(1−e) log(1−e) is the binary entropy and e is the fraction of errors in the sifted keys. This value becomes known to the legitimate parties after error correction and key verification: After verification, the keys are likely to coincide; therefore, by the number of positions in which corrections have taken place, the legitimate parties know the error rates in the sifted keys. Then, to obtain a formula for the achievable secret key rate, the legitimate parties have to evaluate the H(A′|E).
For any linear completely positive trace-non increasing map γ the following inequality holds: H(A′|E)≥Q0/Q+Q1/Q H(A′|E)₁,
Where, H(A′|E) is calculated for state ρA′BE and H(A′|E)₁ is calculated for state ρ¹_{A′BE}. Consider, quantum conditional entropy in terms of quantum relative entropy, H(A′|E)=−D(ρA′E∥IA′⊗ρE) Where, D(ρ∥σ)=Tr(ρ log ρ)−Tr(ρ log σ) and it is joint convex with respect to its arguments. D(pρ₁+(1−p) ρ₂∥pσ₁+(1−p)σ₂)≤pD(ρ₁∥σ₁)+(1−p) D(ρ₂∥σ₂) for any state ρ_{1,2}, σ_{1,2} and 0≤p≤1. Further, D (pρ₁+(1−p) ρ₂∥pσ₁+(1−p) σ₂)≤pD(ρ₁∥σ₁)+(1−p) D(ρ₂∥σ₂) for any state ρ_{1,2}, σ_{1,2} and 0≤p≤1. Then, the statement of this theorem is a simple consequence of the fact that the state ρμu is a mixture of states with a certain number of photons, linearity of γ, and joint convexity of the quantum relative entropy.

$$ρ μ u = P 0 ρ μ u P 0 + P 1 ρμ u P 1 + P \geq 2 ρ μ u P \geq 2 , \qquad Equation ( 8 )$$

### Where,

$$P \geq 2 = {\sum }_{j = 2}^{∞} {P}_{j} .$$

Therefore, in view of the linearity of γ,

$$\begin{matrix}ρ {A}^{′} BE = {Q}^{- 1} ( {IA}^{′} ⊗ γ ) ρ {A}^{′} A \\ = \frac{{Q}_{0}}{Q} {ρ}_{{A}^{′} BE}^{0} + \frac{{Q}_{1}}{Q} {ρ}_{{A}^{′} BE}^{1} + \frac{{Q}_{\geq 2}}{Q} {ρ}_{{A}^{′} BE}^{\geq 2}\end{matrix} \qquad \begin{matrix}Equation 9 \\ Equation 10\end{matrix}$$

### Where,

$${ρ}_{{A}^{′} BE}^{\geq 2} = {Q}_{\geq 2}^{- 1} Tr ( {IA}^{′} ⊗ γ ) {(}^{∼} {ρ}_{{A}^{′} A}^{\geq 2} ) \qquad Equation 11$$

$$Q \geq 2 = Tr ( {IA}^{′} ⊗ γ ) {(}^{∼} {ρ}_{{A}^{′} A}^{\geq 2} ) \qquad Equation 12$$

$${ρ}_{{A}^{′} A}^{∼ \geq 2} = \frac{1}{2} {\sum }_{u = 0}^{1} \vert u > {A}^{′} < u \vert ⊗ P \geq 2 ρ μ u P \geq 2 \qquad Equation 13$$

Then, due to the joint convexity of the quantum relative entropy, H(A′|E)≥Q0/Q H(A′|E)₀+Q1/Q H(A′|E)₁+Q≥2/Q H(A′|E)≥2≥Q0/Q+Q1/Q H(A′|E)₁.
Here, H (A′|E)0=H(A′)=1 because vacuum states contain no information about the sent bit. It is clear from the theorem that the problem of obtaining achievable key rates in the case of arbitrary collective attacks in the experimental quantum key distribution scenario with weak coherent pulses splits into two subproblems: 1. The estimation of the factor Q1/Q, i.e., the fraction of the position in the sifted key obtained from the single-photon pulses, 2. The estimation of the adversary's ignorance H(A′|E)₁ about a single bit of this part of the key. The expression for H (A′|E)₁ is well known and has the form H(A′|E)=1−h(e₁).
The Decoy-DPS state method allows for estimating the factor Q1/Q, as well as the value of e1, efficiently. Note that in the theorem, equality holds for the PNS attacks in the class of collective attacks.

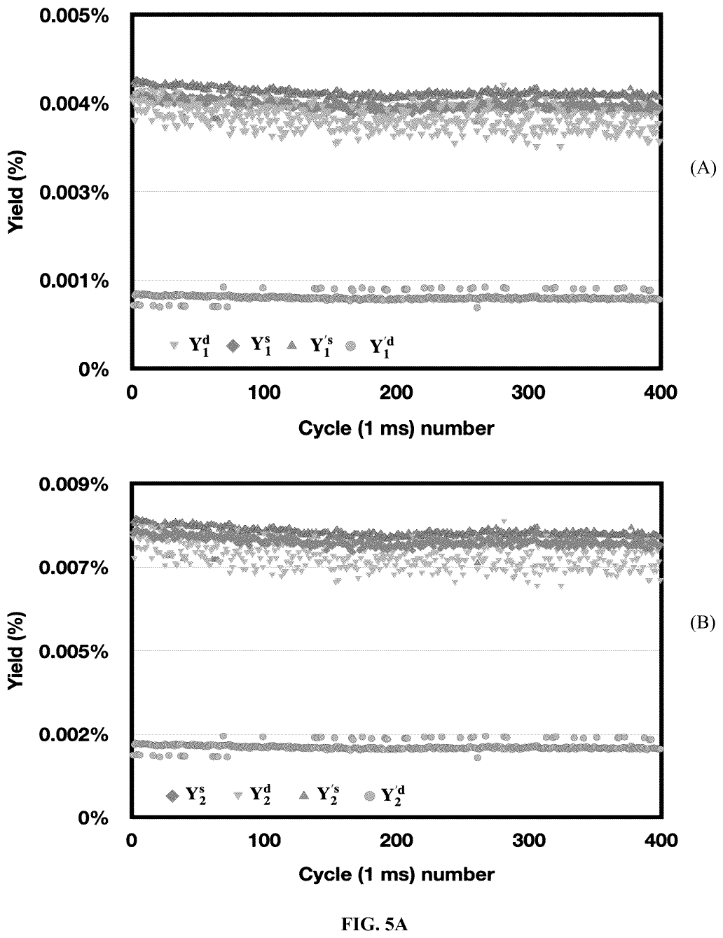

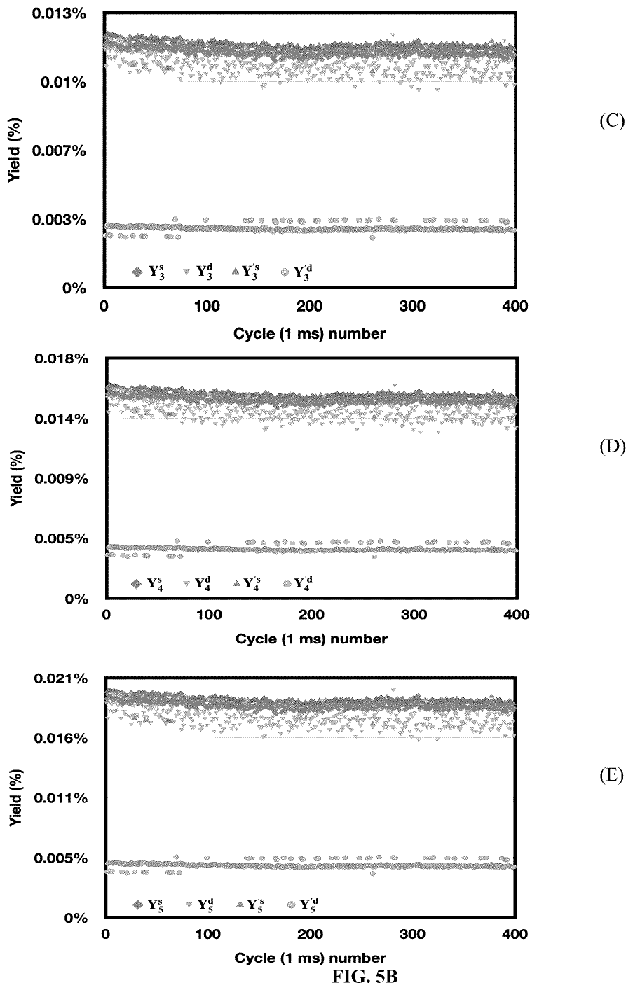

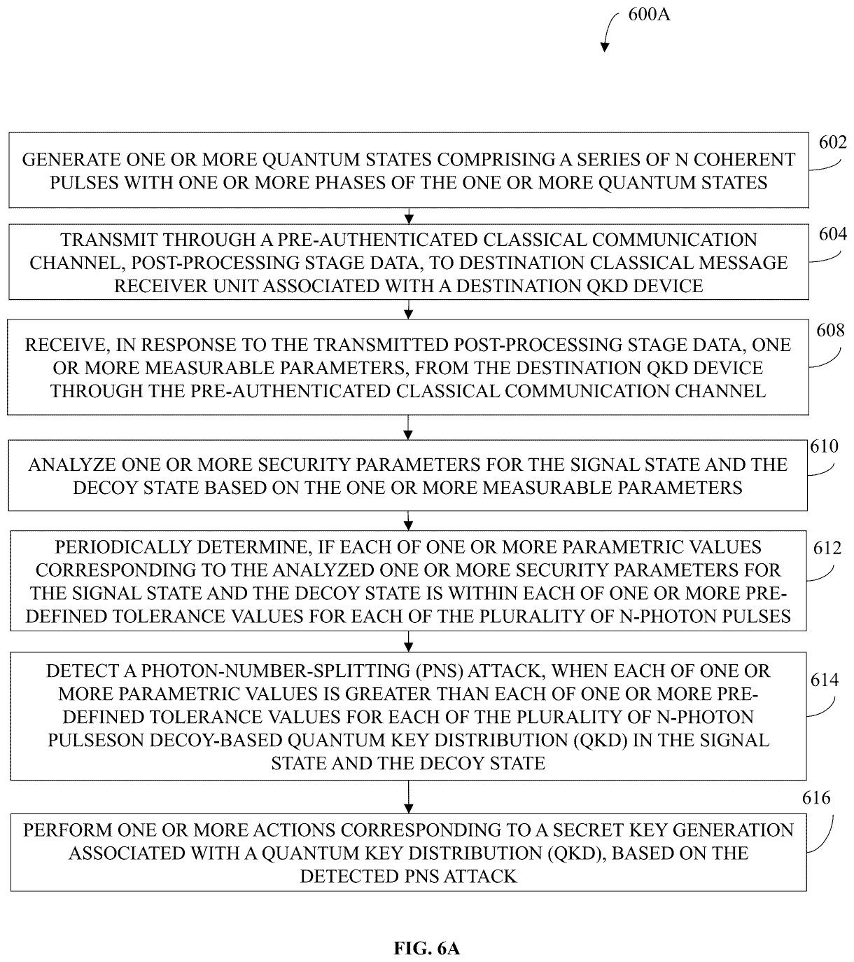

Consider a scenario of resiliency against PNS attacks using the system 100. In FIGS. 5A and 5B, plots of the photon number dependent (equation (4)) (n=1, 2, 3, 4, 5) yield of signal and decoy pulses with the cycle number (one cycle is of duration e.g., 67 Milliseconds) of the QKD setup before and after the action of PNS attack is shown. The tolerance value for the photon-dependent yield of both pulses in the QKD setup is ±10⁻⁵.

In FIGS. 5A and 5B,

$${Y}_{n}^{s} and {Y}_{n}^{d} ( n = 1 , 2 , 3 , 4 )$$

represent the photon number-dependent yield of the signal and decoy pulses respectively before the PNS attack, whereas Y′ₙ^{s} and Y′ₙ^{d} represents the respective value after the PNS attack. Further, plot A, plot B, plot C, plot D, and plot E in FIGS. 5A and 5B represent single-photon yield, two-photon yield, three-photon yield, four-photon yield, and five-photon yield, respectively. From the plots, it is clear that the PNS attack can be detected in the QKD setup from the photon number dependent (n=1, 2, 3, 4) yield difference between the signal and decoy pulses. If the QKD system 100 is robust against PNS attack, it is robust against general collective attacks by the application of the previous theorem. In such settings, the QKD system 100 may generate secure keys at a rate of e.g., 1 Kbps when the overall loss may be e.g., 33 dB using the standard Indium Gallium Arsenide (InGaAs) avalanche photodiode at e.g., 10% efficiency. The observed QBER may be in the range of 2.5 to 4%.

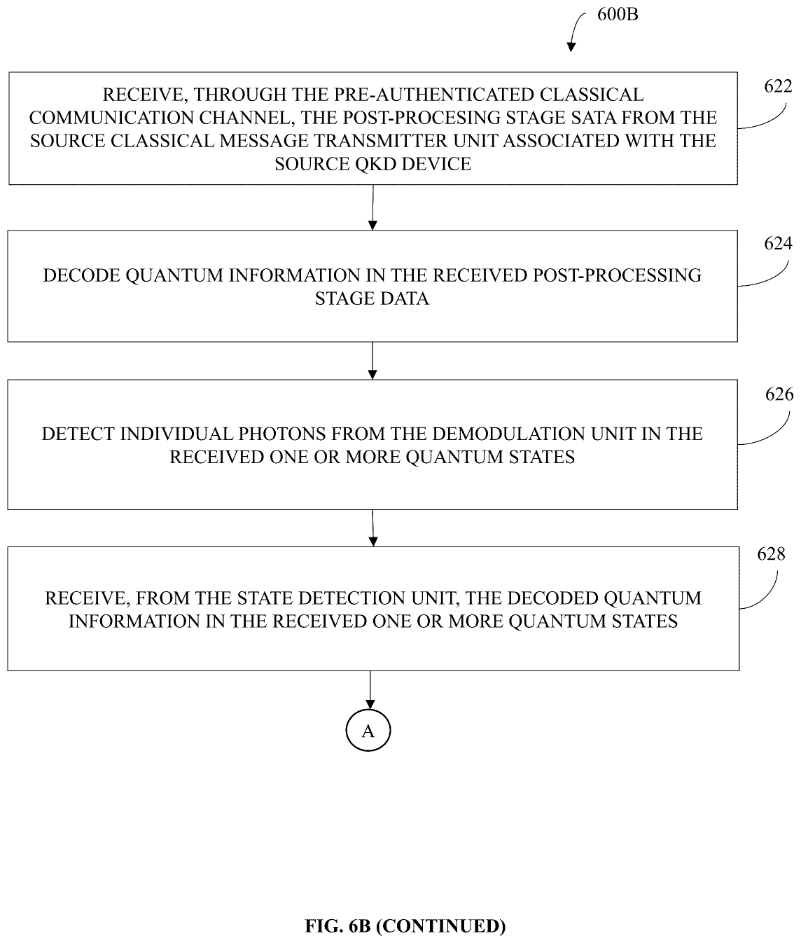

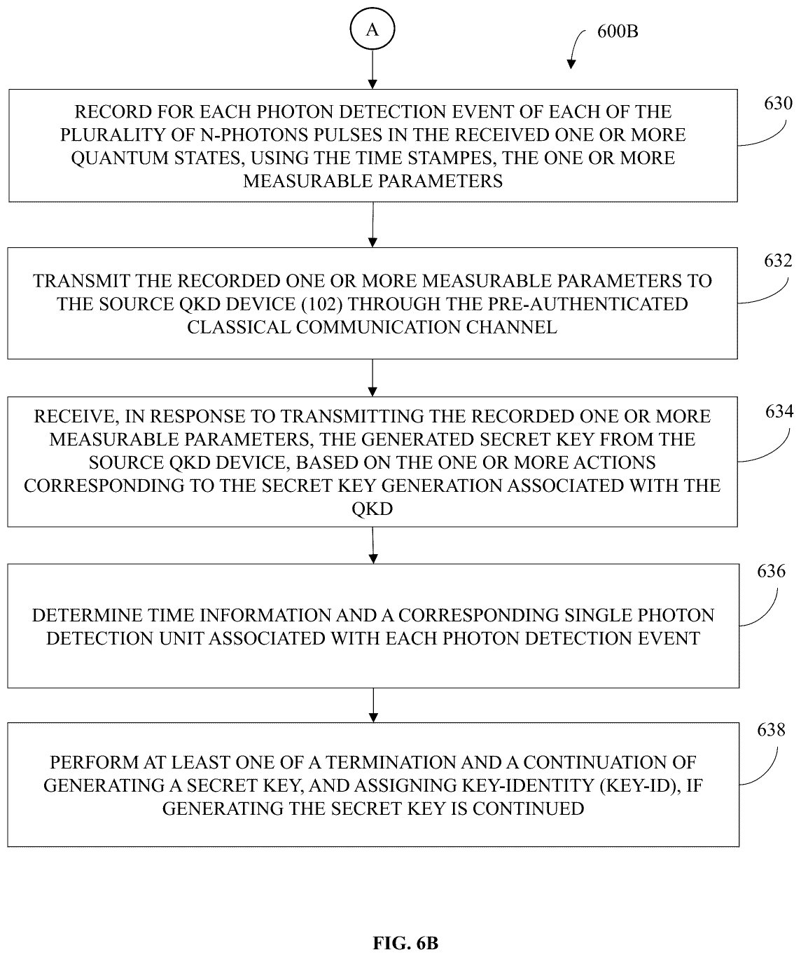

FIG. 6A is an exemplary flow diagram representation of a method 600A for detecting a Photon-Number-Splitting (PNS) attack in a secure quantum communication channel during Quantum Key Distribution (QKD), in accordance with an embodiment of the present disclosure.

At block 602, the method 600A includes generating, by a source Quantum Key Distribution (QKD) device 102 associated with a system 100, one or more quantum states comprising a series of N coherent pulses with one or more phases of the one or more quantum states. The one or more quantum states comprises a signal state generated using a signal unit 112 and a decoy state generated using a decoy unit 114.

At block 604, the method 600A includes transmitting, by the source QKD device 102, through a pre-authenticated classical communication channel, post-processing stage data, to the destination classical message receiver unit 140 associated with the destination QKD device 104. At block 606, the method 600A includes receiving, by the source QKD device 102, in response to the transmitted post-processing stage data, one or more measurable parameters, from the destination QKD device 104 through the pre-authenticated classical communication channel.

At block 608, the method 600A includes analyzing, by the source QKD device 102, one or more security parameters for the signal state and the decoy state based on the one or more measurable parameters. At block 610, the method 600A includes periodically determining, by the source QKD device 102, if each of one or more parametric values corresponding to the analyzed one or more security parameters for the signal state and the decoy state is within each of one or more pre-defined tolerance values for each of the plurality of n-photon pulses.

At block 612, the method 600A includes detecting by the source QKD device 102, a Photon-Number-Splitting (PNS) attack on decoy-based Quantum Key Distribution (QKD) in the signal state and the decoy state, when each of one or more parametric values is greater than each of one or more pre-defined tolerance values for each of the plurality of n-photon pulses. The PNS attack is determined using a differential statistical analysis technique. At block 614, the method 600A includes performing, by the source QKD device 102, one or more actions corresponding to a secret key generation associated with a Quantum Key Distribution (QKD), based on the detected PNS attack.

The method 600A may be implemented in any suitable hardware, software, firmware, or combination thereof. The order in which the method 600A is described is not intended to be construed as a limitation, and any number of the described method blocks may be combined or otherwise performed in any order to implement the method 600A or an alternate method. Additionally, individual blocks may be deleted from the method 600A without departing from the spirit and scope of the present disclosure described herein. Furthermore, the method 600A may be implemented in any suitable hardware, software, firmware, or a combination thereof, that exists in the related art or that is later developed. The method 600A describes, without limitation, the implementation of the system 100. A person of skill in the art will understand that method 600A may be modified appropriately for implementation in various manners without departing from the scope and spirit of the disclosure.

FIG. 6B is an exemplary flow diagram representation of a method 600B for transmitting a recorded one or more measurable parameters to a source QKD device 102, in accordance with an embodiment of the present disclosure.

At block 622, the method 600B includes receiving, by the destination QKD device 104, through the pre-authenticated classical communication channel, the post-processing stage data from the source classical message transmitter unit 116 associated with the source QKD device 102.

At block 624, the method 600B includes decoding, by the destination QKD device 104, quantum information in the received post-processing stage data. At block 626, the method 600B includes detecting, by the destination QKD device 104, individual photons from the demodulation unit 134 in the received one or more quantum states. At block 628, the method 600B includes receiving, by the destination QKD device 104, from the state detection unit 132, the decoded quantum information in the received one or more quantum states.

At block 630, the method 600B includes recording, by the destination QKD device 104, for each photon detection event of each of the plurality of n-photons pulses in the received one or more quantum states, using the time stamps, the one or more measurable parameters.

At block 632, the method 400B includes transmitting, by the destination QKD device 104, the recorded one or more measurable parameters to the source QKD device 102 through the pre-authenticated classical communication channel. At block 634, the method 600B includes receiving, by the destination QKD device 104, in response to transmitting the recorded one or more measurable parameters, the generated secret key from the source QKD device 102, based on the one or more actions corresponding to the secret key generation associated with the QKD.

At block 636, the method 600B includes determining, by the destination QKD device 104, time information and a corresponding single photon detection unit 136 associated with each photon detection event. At block 638, the method 600B includes performing, by the destination QKD device 104, at least one of a termination and a continuation of generating a secret key, and assigning key-identity (key-ID), if generating the secret key is continued, wherein the source QKD device 102 and the destination QKD device 104, exchanges timing information, coordinate transmission and detection of the one or more quantum states through a synchronization channel 130.

The method 600B may be implemented in any suitable hardware, software, firmware, or combination thereof. The order in which the method 600B is described is not intended to be construed as a limitation, and any number of the described method blocks may be combined or otherwise performed in any order to implement the method 600B or an alternate method. Additionally, individual blocks may be deleted from the method 600B without departing from the spirit and scope of the present disclosure described herein. Furthermore, the method 600B may be implemented in any suitable hardware, software, firmware, or a combination thereof, that exists in the related art or that is later developed. The method 600B describes, without limitation, the implementation of the system 100. A person of skill in the art will understand that method 600B may be modified appropriately for implementation in various manners without departing from the scope and spirit of the disclosure.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W), and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or Central Processing Unit (CPU). The CPUs are interconnected via a system bus to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The specification has described a method and a system for distributing quantum keys on a quantum device. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all the acts need to be necessarily performed. Also, those acts that are not dependent on other acts may be performed in parallel with the other acts. The scope of embodiments is by no means limited by these specific examples.

We claim:

1. A system for detecting a Photon-Number-Splitting (PNS) attack in a decoy Differential Phase Shift (DPS) Quantum Key Distribution (QKD), the system comprising:
a source Quantum Key Distribution (QKD) device comprising:
a state preparation unit configured to:
generate one or more quantum states comprising a series of N coherent pulses with one or more phases of the one or more quantum states, wherein the one or more quantum states comprises a signal state generated using a signal unit and a decoy state generated using a source security analysis unit;
a source post-processing unit comprising:
a source classical message transmitter unit configured to:
transmit, through a pre-authenticated classical communication channel, post-processing stage data, to a destination classical message receiver unit associated with a destination Quantum Key Distribution (QKD) device;
a source classical message receiver unit configured to:
receive, in response to the transmitted post-processing stage data, one or more measurable parameters, from the destination classical message receiver unit associated with the destination QKD device, through the pre-authenticated classical communication channel;
the source security analysis unit configured to:
analyze one or more security parameters for the signal state and the decoy state based on the one or more measurable parameters;
a source measure and monitor unit configured to:
periodically determine, if each of one or more parametric values corresponding to the analyzed one or more security parameters for the signal state and the decoy state is within each of one or more pre-defined tolerance values for each of the plurality of n-photon pulses;
detect a Photon-Number-Splitting (PNS) attack decoy-based Quantum Key Distribution (QKD) in the signal state and the decoy state, when each of one or more parametric values is greater than each of one or more pre-defined tolerance values for each of the plurality of n-photon pulses, wherein the PNS attack is determined using a differential statistical analysis technique; and
a source key generation unit and a source key management unit configured to:
perform one or more actions corresponding to a secret key generation associated with a Quantum Key Distribution (QKD), based on the detected PNS attack; and
the destination QKD device comprising:
a state detection unit comprising:
a demodulation unit configured to:
receive, through the pre-authenticated communication channel, the post-processing stage data from the source classical message transmitter unit associated with the source QKD device;
decode quantum information in the received post-processing stage data;
a single photon detection unit configured to:
detect individual photons from the demodulation unit in the received post-processing stage data;
a destination post-processing unit comprising:
the destination classical message receiver unit configured to:
receive, from the state detection unit, the decoded quantum information in the received one or more quantum states;
record, for each photon detection event of each of the plurality of n-photons pulses in the received one or more quantum states, using the time stamps, the one or more measurable parameters;
a destination classical message transmitter unit configured to:
transmit the recorded one or more measurable parameters to the source QKD device through the pre-authenticated classical communication channel; and
the destination classical message receiver unit configured to:
receive, in response to transmitting the recorded one or more measurable parameters, the generated secret key from the source QKD device, based on the one or more actions corresponding to the secret key generation associated with the QKD.
a destination measure and monitor unit configured to:
determine time information and a corresponding single photon detection unit associated with each photon detection event; and
a destination key generation unit and a destination key management unit configured to:
perform at least one of a termination and a continuation of generating a secret key, and assigning key-identity (key-ID), if the secret key generation is continued; and
a synchronization channel configured to exchange timing information of the source QKD device with the destination QKD device, and coordinate transmission and detection of the one or more quantum states, for synchronizing the clocks of the source QKD device with the destination QKD device to correlate the exchanged timing information.

2. The system as claimed in claim 1, wherein, to analyze the one or more security parameters for the signal state and the decoy state, the source security analysis unit is further configured to:
determine, if each of the one or more parametric values corresponding to a photon number dependent yield of the plurality of n-photon pulses in the signal state and the decoy state is within each of the one or more pre-defined tolerance values for each of the plurality of n-photon pulses; and
determine, if each of the one or more parametric values corresponding to a photon number dependent quantum bit error rate (QBER) of the plurality of n-photon pulses in the signal state and the decoy state is within each of the one or more pre-defined tolerance values for each of the plurality of n-photon pulses.

3. The system as claimed in claim 1, wherein the source security analysis unit is further configured to:
monitor channel losses and induced errors for the signal state and the decoy states are constant over the quantum communication channel, to detect the PNS attack.

4. The system as claimed in claim 1, wherein performing the one or more actions comprises at least one of termination of secret key generation, a continuation of secret key generation, discarding the plurality of n-photon pulses, error correction for the photon detection event, privacy amplification, calculate a lower bound of a single photon yield, calculate an upper bound on a single photon quantum bit error rate (QBER), calculate a theoretical secret key rate, calculate a compression to be applied on an error corrected raw secret keys, compress the secret keys, and generate secure secret keys.

5. The system as claimed in claim 1, wherein the one or more security parameters comprise at least one of a photon number dependent yield, a photon dependent yield of at least one of the signal state and the decoy state pulses, a photon dependent yield quantum bit error rate (QBER), and a photon dependent QBER.

6. The system as claimed in claim 1, wherein the one or more measurable parameters comprise at least one of a pulse gain and a quantum bit error rate (QBER) for the signal state and the decoy state.

7. A method for detecting a Photon-Number-Splitting (PNS) attack in a decoy Differential Phase Shift (DPS) Quantum Key Distribution (QKD), the method comprising:
generating, by a source Quantum Key Distribution (QKD) device associated with a system, one or more quantum states comprising a series of N coherent pulses with one or more phases of the one or more quantum states, wherein the one or more quantum states comprises a signal state generated using a signal unit and a decoy state generated using a decoy unit;
transmitting, by the source QKD device, through a pre-authenticated classical communication channel, post-processing stage data, to a destination classical message receiver unit associated with a destination Quantum Key Distribution (QKD) device;
receiving, by the source QKD device, in response to the transmitted post-processing stage data, one or more measurable parameters, from the destination QKD device through the pre-authenticated classical communication channel;
analyzing, by the source QKD device, one or more security parameters for the signal state and the decoy state based on the one or more measurable parameters;
periodically determining, by the source QKD device, if each of one or more parametric values corresponding to the analyzed one or more security parameters for the signal state and the decoy state is within each of one or more pre-defined tolerance values for each of the plurality of n-photon pulses;
detecting, by the source QKD device, a Photon-Number-Splitting (PNS) attack on decoy-based Quantum Key Distribution (QKD) in the signal state and the decoy state, when each of one or more parametric values is greater than each of one or more pre-defined tolerance values for each of the plurality of n-photon pulses, wherein the PNS attack is determined using a differential statistical analysis technique; and
performing, by the source QKD device, one or more actions corresponding to a secret key generation associated with a Quantum Key Distribution (QKD), based on the detected PNS attack.

8. The method as claimed in claim 7 further comprising:
receiving, by the destination QKD device, through the pre-authenticated classical communication channel, the post-processing stage data from the source classical message transmitter unit associated with the source QKD device;
decoding, by the destination QKD device, quantum information in the received post-processing stage data;
detecting, by the destination QKD device, individual photons from the demodulation unit in the received one or more quantum states;
receiving, by the destination QKD device, from the state detection unit, the decoded quantum information in the received one or more quantum states;
recording, by the destination QKD device, for each photon detection event of each of the plurality of n-photons pulses in the received one or more quantum states, using the time stamps, the one or more measurable parameters;
transmitting, by the destination QKD device, the recorded one or more measurable parameters to the source QKD device through the pre-authenticated classical communication channel; and
receiving, by the destination QKD device, in response to transmitting the recorded one or more measurable parameters, the generated secret key from the source QKD device, based on the one or more actions corresponding to the secret key generation associated with the QKD;
determining, by the destination QKD device, time information and a corresponding single photon detection unit associated with each photon detection event; and
performing, by the destination QKD device, at least one of a termination and a continuation of generating a secret key, and assigning key-identity (key-ID), if generating the secret key is continued, wherein the source QKD device and the destination QKD device, exchanges timing information, coordinate transmission and detection of the one or more quantum states through a synchronization channel.

9. The method as claimed in claim 7, wherein analyzing the one or more security parameters for the signal state and the decoy state, further comprises:
determining, by the source QKD device, if each of the one or more parametric values corresponding to a photon number dependent yield of the plurality of n-photon pulses in the signal state and the decoy state is within each of the one or more pre-defined tolerance values for each of the plurality of n-photon pulses; and
determining, by the source QKD device, if each of the one or more parametric values corresponding to a photon number dependent quantum bit error rate (QBER) of the plurality of n-photon pulses in the signal state and the decoy state is within each of the one or more pre-defined tolerance values for each of the plurality of n-photon pulses.

10. The method as claimed in claim 7 further comprising:
monitoring by the source QKD device, channel losses and induced errors for the signal state and the decoy states are constant over the quantum communication channel, to detect the PNS attack.

11. The method as claimed in claim 7, wherein performing the one or more actions comprises at least one of termination of secret key generation, a continuation of secret key generation, discarding the plurality of n-photon pulses, error correction for the photon detection event, privacy amplification, calculate a lower bound of a single photon yield, calculate an upper bound on a single photon quantum bit error rate (QBER), calculate a theoretical secret key rate, calculate a compression to be applied on an error corrected raw secret keys, compress the secret keys, and generate secure secret keys.

12. The method as claimed in claim 7, wherein the one or more security parameters comprise at least one of a photon number dependent yield, a photon dependent yield of at least one of the signal state and the decoy state pulses, a photon dependent yield quantum bit error rate (QBER), and a photon dependent QBER.

13. The method as claimed in claim 7, wherein the one or more measurable parameters comprise at least one of a pulse gain and a quantum bit error rate (QBER) for the signal state and the decoy state.
